(19) United States
(12) Patent Application Publication
(10) Pub. No.: US 2004/0054576 A1
(43) Pub. Date: Mar. 18, 2004

(54) Processing messages in communication system

(76) Inventors: Mikko Kanerva, Helsinki (FI); Tuuli Ahava, Helsinki (FI); Heikki Einola, Espoo (FI); Maija Kamppuri, Helsinki (FI); Taina Kujanpaa, Helsinki (FI); Anne Parviainen, Helsinki (FI)

Correspondence Address: Steven R. Funk, Crawford Maunu, 1270 Northland Drive, Suite 390, Mendota Heights, MN, 55120, US

(21) Appl. No.: 10/250,344

(22) PCT Filed: Dec. 18, 2001
(86) PCT No.: PCT/FI01/01121

(30) Foreign Application Priority Data
Dec. 28, 2000 (FI) 20002872

(51) Int. Cl. G06F 17/60

(52) U.S. Cl. 705/14

(57) ABSTRACT

The present invention relates to a communication system comprising a sub-scriber A terminal (MSA), a subscriber B terminal (MSB), a message centre (MC) for transmitting a message from subscriber A to subscriber B on the ba-sis of address data included in the message, and a billing database (31) for maintaining subscriber-specific billing data. The system also comprises means for retrieving information from a third party from a database (DB), means for transmitting said information from a third party to subscriber B in connection with a message sent by subscriber A, and means for adding at least part of the charge incurred by transmitting the message and/or at least part of the cost of the contents of the message to the billing database (31) onto the advertiser's account.

### BACKGROUND OF THE INVENTION

The invention relates to mobile communication systems and particularly to the transmission of various messages therein.

Sending messages in mobile communication networks is a previously known and popular service. For instance in the GSM network (Global System for Mobile Communications), the short message service is widely used, allowing a mobile subscriber to send text messages having a maximum length of 160 characters to another mobile subscriber. In this service, the sender of the short message usually pays for the transmission of the message via a short message service centre all the way to the receiver. In the future, mobile communication networks will offer multimedia-messaging services, allowing a considerable increase in the size of the message owing to different kind of contents and optional attachment files. Terminals of a fixed network will also be able to send and receive MMS messages, which also affects the increase in the size of the messages.

A problem in the above arrangement is that bigger messages to be transmitted require much radio capacity. Therefore, the use of radio capacity has to be chargeable. In practice this means that an operator may charge separately for sending and receiving. It is simple to charge the sender for the sending price, as sending is a conscious decision. Instead, charging the sender for the receiving price is more difficult, since it is uncertain if the message is transmitted to the mobile station or reaches the destination at all. The receiver may be equally reluctant to pay the receiving price if he/she is not expecting an extensive message and is therefore unaware of its contents.

### BRIEF DESCRIPTION OF THE INVENTION

The object of the invention is thus to provide a method and an apparatus for implementing the method so as to solve the above problems. The object of the invention is achieved with a method and system that are characterized by what is disclosed in the independent claims.

‘Information from a third party’ refers to any kind of information owned, produced or delivered by the third party, although in the following description advertisements are used by way of example. Consequently, the third party is referred to as an advertiser in the description.

In the present application, the term ‘billing database’ refers generally to any unit, function or application maintaining real-time billing data. An advertiser's account refers to a list or register, into which the charges a given advertiser will be billed for are collected. The term does not refer to the way billing is carried out.

The invention is based on sending an advertisement to a receiver in connection with a message, whereby the advertiser pays partly or entirely for the costs of transmitting the message. The advertiser may also pay at least a part of the price of the content of the message being transmitted. The payment may even exceed the actual cost of transmitting. The advertisement can be attached to the actual message or be sent separately for instance before the actual message. The advertisement can be e.g. an image, video, sound, text or a combination thereof.

The method and system of the invention provide the advantage that extensive messages can be sent in a mobile communication network without high transmission costs to the sender and/or receiver. At the same time, advertisers are offered a new way to transmit advertisements directly to consumers.

In a first preferred embodiment of the method of the invention, a message is first sent from the subscriber terminal of subscriber A to a message centre. In the message centre an advertisement is added in connection with the message. The message and the advertisement are then sent from the message centre to the subscriber terminal of subscriber B.

In a second preferred embodiment of the method of the invention, an advertisement is first loaded into the subscriber terminal of subscriber A and said advertisement is then sent from subscriber A in connection with a message to be transmitted to subscriber B. This can be achieved for example by the subscriber establishing a connection to a company's www page (World Wide Web) and loading said company's advertisement into the memory of his/her mobile station. This way the loaded advertisements can later be attached to messages, when desired.

In a third preferred embodiment of the method of the invention, a confirmation of transmission is sent to the advertiser in response to successful transmission of an advertisement produced by the advertiser. This feature is useful for instance when advertisements are loaded in advance from www pages into a mobile station, and, when the advertisements are loaded, the advertiser does not yet know if the advertisement is transmitted to another subscriber at all. Having obtained the confirmation of the transmission of an advertisement to a receiver in connection with a message, the advertiser is willing to pay the price of the transmission. This confirmation can be transmitted to the advertiser either immediately after the message was sent or later, for example by the subscriber proving that he/she sent said advertiser's advertisement×times, in which case the advertiser pays later the costs caused by these transmissions. The confirmation of transmission may be generated and sent for instance when an advertisement is successfully added in connection with a message either in the subscriber terminal of subscriber A or in a message centre or when subscriber B successfully receives the message and the advertisement.

In a fourth preferred embodiment of the method of the invention, a confirmation of consumption is sent to the advertiser in response to successful consumption of an advertisement produced by the advertiser. Consumption refers to for example viewing, listening to, seeing or hearing the advertisement.

In a fifth preferred embodiment of the method of the invention, an advertisement is transmitted in connection with a message in such a way that subscriber B has to receive the advertisement before he/she is able to open the actual message. The aim here is for the receiver to really see or hear said advertisement. In case of a pictorial advertisement, the advertisement can be shown first and only then is the receiver allowed to open the actual message. In case of an audio advertisement, the actual message is not shown until the receiver has heard the entire advertisement. In this case, an additional requirement may be for example that the volume of the receiver's terminal is not adjusted to zero. Alternatively an advertisement may be transmitted in connection with a message in such a way that subscriber B has to receive the advertisement during opening, viewing or consuming the actual message.

In a first preferred embodiment of the system of the invention, subscriber A's subscriber terminal comprises means for including information on advertisements accepted by subscriber A in a message to be transmitted from subscriber A, and said means for retrieving an advertisement from a database are arranged to retrieve such an advertisement from the database that subscriber A allows to be transmitted according to the information in the message. In this case, subscriber A may for example transmit in a message to the message centre a list of advertisers whose advertisements can be transmitted in connection with his/her messages to subscriber B. The message centre takes this into account when selecting the advertisement.

In a second preferred embodiment of the system of the invention, the system comprises a first register for storing information on advertisements accepted or preferred by subscriber A, and said means for retrieving an advertisement from a database are arranged to retrieve such an advertisement from the database that subscriber A allows to be transmitted according to the information stored in said first register. This means that data is stored in a database of the network about the kind of advertisements subscriber A accepts or prefers to be attached to his/her messages. This may involve a list of advertisers or separate advertisements, for example, or requirements limiting the selection of topics. This allows subscriber A to accept or prefer advertisements for given car makes and all advertisements relating to sports gear, for example. The message centre or another system element retrieves from the register the information stored on subscriber A before the advertisement is transmitted to subscriber B. It should also be noted that the same kind of functionality can be included in a register for information on advertisements not accepted by the subscriber A.

In a third preferred embodiment of the system of the invention, the system comprises a second register for storing information on advertisements accepted or preferred by subscriber B, and said means for retrieving an advertisement from a database are arranged to retrieve such an advertisement from the database that subscriber B allows to be received according to the information stored in said second register. This feature allows subscriber B to determine the advertisements and the advertisers and topics the advertisements of which he/she wants or likes to receive in connection with messages. In this case a message centre, for example, retrieves the information on subscriber B stored in the register before the advertisement is transmitted to subscriber B. This also allows subscriber B to determine the largest total size of an accepted advertisement and a message he/she is prepared to receive in order for a single message not to use up too much capacity. It should also be noted that the same kind of functionality can be included in a register for information on advertisements not accepted by the subscriber B. An alternative would be for subscriber B to determine that no advertisements at all are to be transmitted to him/her. This means that the transmission of the message has to be paid for either by subscriber A or B. The advertisement may alternatively be selected on criteria set by a network operator, a regulator or a religious instance. In this case advertisements relating to alcoholic drinks or cigarettes may for instance be forbidden for subscribers under the age of 18.

In other preferred embodiments of the system of the invention, the system comprises means for updating the information in said first or second registers by means of short messages or the WAP technology (Wireless Application protocol) or via a www page. These means facilitate the changes in the desires and restrictions of subscribers A and B regarding advertisements.

The preferred embodiments of the invention are disclosed in the dependent claims.

### BRIEF DESCRIPTION OF THE DRAWINGS

In the following the invention will be described in greater detail by means of preferred embodiments with reference to the attached drawings, in which

FIG. 1 is a flow diagram of a method of the invention;

FIG. 2 is a flow diagram of a method of the invention;

FIG. 3 is a block diagram of a system of the invention;

FIG. 4 is a block diagram of a detail of the system of the invention;

FIG. 5 is a block diagram of a detail of the system of the invention; and

FIG. 6 is a block diagram of a message centre of the invention.

### DETAILED DESCRIPTION OF THE INVENTION

The present description and the figures describe advertisements to be attached to messages by way of example. However, ‘information from a third party’, as defined by the invention, may also include other information.

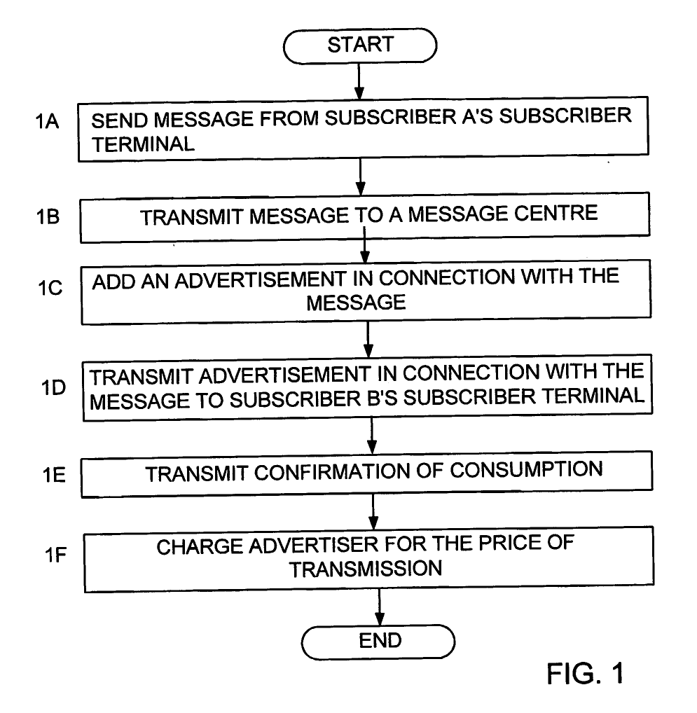

FIG. 1 is a flow diagram of a method of the invention. In step 1A subscriber A sends a message from his/her subscriber terminal. The message is in step 1B transmitted to a message centre of the mobile communication system. In step 1C the message centre adds an advertisement in connection with the message according to criteria set by for instance subscriber A or subscriber B. The criteria for selecting the advertisement may be stored in a database in connection with the message centre. In step 1D the message and the advertisement are transmitted to the subscriber terminal of subscriber B. Subscriber B receives the m ssage and reads the advertisement. In step 1E a confirmation of consumption is transmitted to the advertiser. In step 1F the advertiser is charged for the transmission of the message.

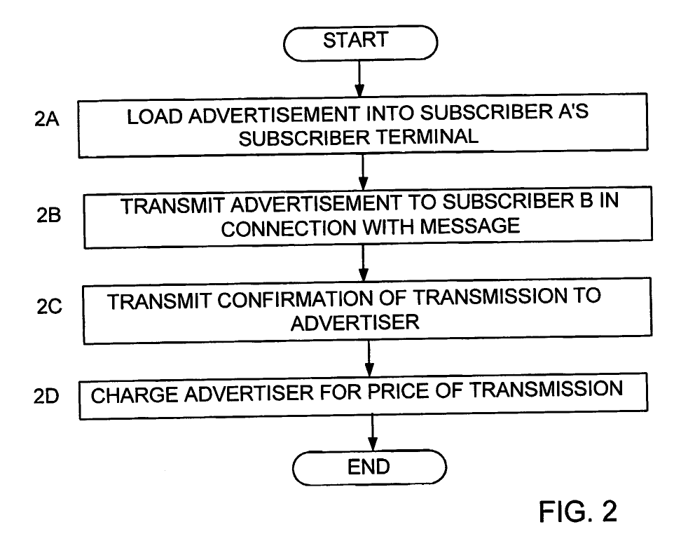

FIG. 2 is a flow diagram of a method of the invention. The assumption in the example is that subscriber A's subscriber terminal is a mobile station operating in a GSM network. In step 2A, subscriber A loads an advertisement into his/her mobile station for example by establishing a connection to a company's www page. When subscriber A wants to send a message and attach an advertisement thereto, he/she retrieves the advertisement from the memory of the mobile station. In step 2B, subscriber A transmits the message, e.g. a short message or a multimedia message, together with the advertisement to subscriber B. Depending on the size of the mobile station's memory and the memory capacity required by the advertisements, several advertisements may be loaded in advance into the mobile station, from which the most suitable for the occasion can be selected. In step 2C, subscriber A transmits a confirmation of transmission, generated in response to the transmission of the advertisement, to the advertiser. This way the advertiser receives information on each transmission of an advertisement. Alternatively the confirmation of transmission may be generated by the network. The advertisement may remain in the memory of subscriber A's mobile station after the transmission, allowing the same advertisement to be transmitted in several messages. The confirmation of transmission sent to the advertiser may then notify of several transmissions, and the advertiser can later pay for the costs of all said transmissions. In step 2D, the advertiser is charged for the price of the message transmission. The advertiser is then able to check the sum to be charged by comparing it with the confirmations of transmission received.

The confirmation of transmission used in this example may also be replaced with a confirmation of actual consumption, which refers to for example viewing, listening to, seeing or hearing the advertisement. The confirmation of the actual consumption of the information may even be required before the advertiser allows the cost to be charged from their account.

As distinct from the above example, the third party may also pay for the contents of the original message in full or partly. In case of for example a chargeable movie, the advertiser could pay for both the transmission and the film show. In addition, subscriber A could even earn money by sending advertisements along with his/her messages, i.e. subscriber A would not only get a free transmission, but also earn (a deposit to the prepaid account, etc.).

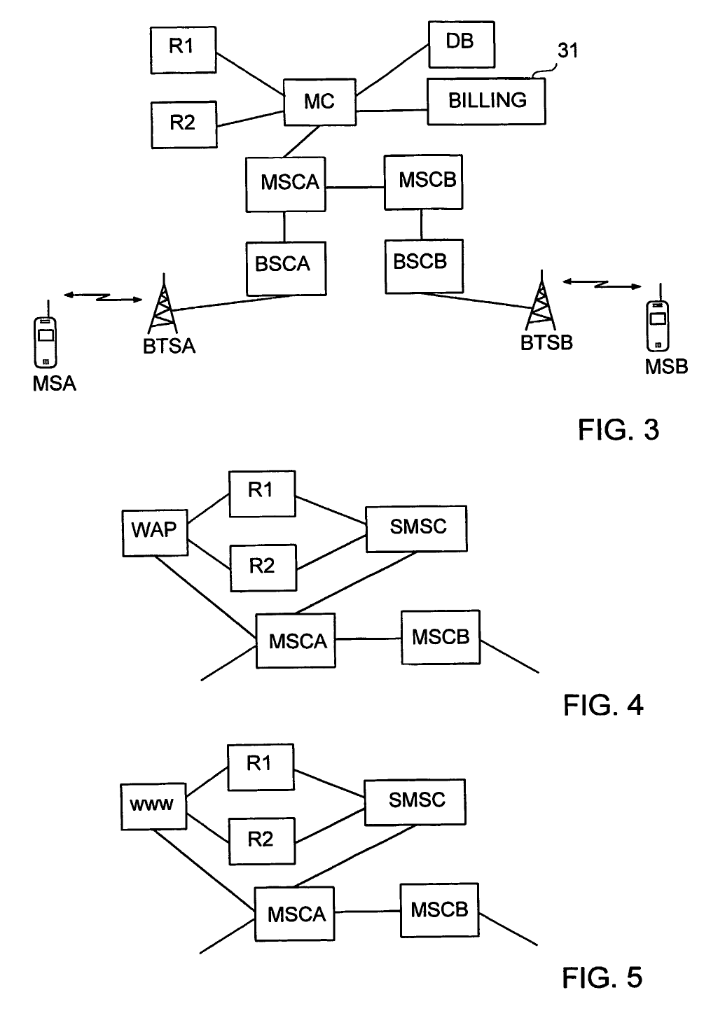

FIG. 3 is a block diagram of a system of the invention. The figure only shows the elements relevant to understanding the invention. The assumption in the example is that the subscriber terminals of subscribers A and B are mobile stations in a GSM network. The system shown comprises a subscriber A terminal MSA, a subscriber B terminal MSB, base stations BTSA, BTSB, base station controllers BSCA, BSCB, mobile switching centres MSCA, MSCB for establishing connections, and a message centre MC, which can be for example a short messaging centre or a multimedia messaging centre. The system further comprises first R1 and second R2 registers in data transmission connection with the message centre MC for subscribers' advertisement profiles, a database DB, in which advertisements to be attached to messages are stored, and a billing database 31. Said registers R1 and R2 and the database DB can also be implemented as one element in the message centre.

When subscriber A wants to send a message and an advertisement to subscriber B, he/she first transmits from the mobile station MSA a message via the base station BTSA, the base station controller BSCA and the mobile switching centre MSCA to the message centre MC. The message centre MC notices that the message is one to which an advertisement is to be added. The message centre MC then retrieves from the first register R1 information on the advertisement profile of subscriber A, i.e. conditions determined by subscriber A as to what kind of advertisements can be added to messages sent by him/her. The conditions may determine for instance that subscriber A accepts all advertisements relating to hobbies and pets, and that he prefers advertisements for dogs' food instead of cats' food (as he owns a dog) and that he does not accept any advertisements related to e.g. adult movies. Next, the message centre MC retrieves from the second register R2 the advertisement profile of subscriber B, i.e. the conditions determined by subscriber B regarding advertisements to be transmitted to him/her. The conditions may determine for instance that subscriber B is most interested in advertisements relating to dogs. In this example, the information in the first R1 and second R2 registers can be updated by means of short messages by subscribers A and B sending a short message to the message centre for updating the information in the registers. The message centre MC uses the information retrieved from the registers R1, R2 to retrieve from the database DB an advertisement that fulfils the wishes of subscribers A and B. This time the database DB could contain a dog food advertisement, which is transmitted in connection with the message via the mobile switching centre MSCB, the base station controller BSCB and the base station BTSB to subscriber B's subscriber terminal MSB. Once the advertisement is selected and transmitted in connection with the message to subscriber B, the company advertising the dog food is charged for the transmission charge of the message, either entirely or partly. In practice this may be carried out by adding data to the billing database 31 about the price of the message transmitted and the producer of the advertisement attached thereto. The charges to be billed from each advertiser can be collected either immediately or later from the billing database. However, the present invention is not related to methods of billing.

The assumption in the above example was that the message centre MC is a general message centre that supports direct advertising and whose advertisement database DB comprises several companies' advertisements. As distinct from this, it is also feasible that one or more advertisers manage the message centre, whereby subscriber A has a narrower selection of advertisements available. There may also be several message centres, allowing subscriber A to choose to which message centre he/she directs messages for example according to what kind of messages he/she wishes to send in connection with the messages. Alternatively the network may select the message centre used. If a condition were stored in the above example in the second register R2 indicating that subscriber B does not allow any advertisements to be transmitted, this can be notified by a message to subscriber A. This allows subscriber A to choose if he/she still wants to send the message, which he/she would have to pay for, or if the message is not transmitted at all. It is also feasible that subscriber B would pay for the transmission of the message either alone or together with subscriber A.

As distinct from the above example, a message can also be sent via the Internet, whereby subscriber A does not use a mobile station, but a PC, for example. In this case the exemplary service could be such that a photo shop has a contract with a network operator, allowing a message to be sent from the photo shop's www page with a photo attached thereto, in such a way that the photo shop attaches its advertisement to the message and pays for the transmission of the message to the receiver. This service could operate for instance as a postcard service, allowing subscriber A, when on a trip, to establish a connection to said photo shop's www page and attach a picture taken on the trip to the message to be sent to subscriber B. The Internet postcard so generated would be transmitted free of charge or at least very inexpensively to subscrib r B.

The GSM technology in the above examples is only an example of the implementation of the invention. In practice, the invention may be applied in a third generation mobile network, for example.

FIG. 4 is a block diagram of a detail of the system of the invention. Other parts of the system shown correspond to the system of FIG. 3, but, in addition, it comprises a WAP server WAP, allowing subscribers A and B to update the information in registers R1, R2 by means of the WAP technology. A mobile station MSA, MSB, having WAP characteristics, is then used to establish a connection via the WAP server to change the information on the advertisement profile.

FIG. 5 is a block diagram of a detail of the system of the invention. Other parts of the system shown correspond to the system of FIG. 3, but, in addition, it comprises a network server www, allowing subscribers A and B to update the information in registers R1, R2 via the Internet. A PC, for example, is then used to establish a connection via the network server www to change the information on the advertisement profile.

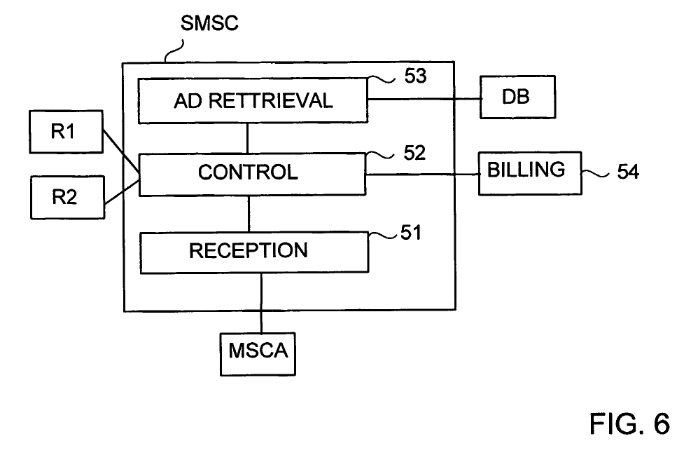

FIG. 6 is a block diagram of a message centre of the invention. In the figure, the message centre is divided into three blocks to facilitate understanding the operation. In practice, a message centre may comprise software and/or different circuits for implementing the functions to the described below. In the figure, the message centre MC comprises a reception block 51, a control block 52 and an advertisement retrieval block 53. When subscriber A transmits to the message centre MC a message, it is received at the reception block 51, which communicates with the mobile switching centre MSCA. Next, the control block 52 retrieves from the first register R1 information on the advertisement profile of subscriber A, and from the second register R2 information on the advertisement profile of subscriber B. The advertisement retrieval block 53 uses the retrieved information to retrieve a suitable advertisement from the database 53. Finally, controlled by the control block 52, the message and the advertisement are transmitted to subscriber B. The control block 52 also transmits data to a billing database 54 on the price of the transmission of the message and the advertiser concerned.

It is obvious to a person skilled in the art that, as technology advances, the inv ntive concept can be implemented in a variety of ways. Thus the invention and its embodiments are not limited to the above examples but may vary within the scope of the claims.

1. A method of processing messages in a communication system, in which method a message is transmitted from subscriber A's subscriber terminal (MSA) to subscriber B's subscriber terminal (MSB), characterized by the steps of:
transmitting information from a third party to subscriber B in connection with said message, and
charging the third party for at least part of the charge incurred by transmitting the message and/or at least part of the price of the contents of the message transmitted.

2. A method as claimed in claim 1, characterized by
transmitting the message from subscriber A's subscriber terminal (MSA) to a message centre (MC),
adding in the message centre (MC) information from a third party in connection with the message,
transmitting the message and the information from a third party from the message centre (MC) to subscriber B's subscriber terminal (MSB).

3. A method as claimed in claim 1, characterized by
loading information from a third party into subscriber A's mobile station (MSA),
transmitting said information from a third party from subscriber A to subscriber B in connection with a message to be transmitted.

4. A method as claimed in claim 2 or 3, characterized by
transmitting to the third party a confirmation of transmission in response to successful transmission of the information from the third party.

5. A method as claimed in claim 2 or 3, characterized by
transmitting to the third party a confirmation of consumption of the information in response to successful consumption, by subscriber B, of the information from the third party.

6. A method as claimed in any one of claims 1 to 5, characterized by
transmitting the information from a third party in connection with a message in such a way that subscriber B has to receive the information from the third party before being able to open the actual message.

7. A method as claimed in any one of claims 1 to 5, characterized by
transmitting the information from a third party in connection with a message in such a way that subscriber B has to consume the information from the third party before being able to open the actual message.

8. A method as claimed in any one of claims 1 to 5, characterized by
transmitting the information from a third party in connection with a message in such a way that subscriber B has to consume the information from the third party when consuming the actual message.

9. A method as claimed in any one of claims 1 to 8, characterized by
selecting the information from a third party to be added in connection with a message based on criteria set by subscriber A.

10. A method as claimed in any one of claims 1 to 8, characterized by
selecting the information from a third party to be added in connection with a message based on criteria set by subscriber B.

11. A method as claimed in any one of claims 1 to 8, characterized by
selecting the information from a third party in connection with a message based on criteria set by at least one of the following parties: network operator, regulator, religious instance and the third party.

12. A communication system comprising a subscriber A terminal (MSA), a subscriber B terminal (MSB), a message centre (MC) for transmitting a message from subscriber A to subscriber B on the basis of address data included in the message, and a billing database (31, 54) for maintaining subscriber-specific billing data, characterized in that the system further comprises
means (53) for retrieving information from a third party from a database (DB),
means (52) for transmitting said information from a third party to subscriber B in connection with a message transmitted from subscriber A, and
means (52) for adding at least part of the charge incurred by transmitting the message and/or at least part of the price of the contents of the message to the billing databas (31, 54) onto the account of the third party.

13. A communication system as claimed in claim 12, charact rized in that subscriber A's subscriber terminal (MSA) further comprises
means for including information on the criteria for selection of information from a third party defined by subscriber A in a message to be transmitted from subscriber A, and
that said means (53) for retrieving information from a third party from the database (DB) are arranged to retrieve from the database (DB) such information from third party that fulfils the criteria defined by subscriber A on the basis of the data included in the message.

14. A communication system as claimed in claim 12 or 13, characterized in that the system further comprises
a first register (R1) for storing information on the criteria for selecting information from third party defined by subscriber A, and
that said means (53) for retrieving information from a third party from the database (DB) are arranged to retrieve from the database (DB) such information from a third party that fulfils the criteria defined by subscriber A to be transmitted on the basis of the data stored in the first register (R1).

15. A communication system as claimed in any one of claims 12 to 14, characterized in that the system further comprises
a second register (R2) for storing information on the criteria for selecting information from a third party defined by subscriber B, and
that said means (53) for retrieving information from a third party from the database (DB) are arranged to retrieve from the database (DB) such information from a third party that fulfils the criteria defined by subscriber B to be received on the basis of the data stored in the second register (R2).

16. A communication system as claimed in any one of claims 12 to 15, characterized in that said criteria for selecting information comprises information about the kind of data accepted, preferred or forbidden.

17. A communication system as claimed in any one of claims 12 to 16, characterized in that the message centre (MC) comprises
means (MC) for updating the data in said first (R1) or second (R2) register on the basis of short messages received from subscriber A or B.

18. A communication system as claimed in any one of claims 12 to 17, characterized in that the system comprises
a WAP server (WAP) via which subscribers A and B can update the data in said first (R1) or second (R2) register.

19. A communication system as claimed in any one of claims 12 to 18, characteriz d in that the system comprises
a network server (www) via which subscribers A and B can update the data in said first (R1) or second (R2) register.

20. A communication system as claimed in any one of claims 12 to 19, characterized in that the database (DB) comprises
information from a third party in the form of sound, video, image or text or a combination thereof.

21. A message centre (MC) for transmitting messages from subscriber A to subscriber B in a communication system, characterized in that the message centre (MC) comprises
means (51) for receiving a message from subscriber A,
means (52) for checking criteria defined by subscriber B for selecting information from a third party to be transmitted in connection with messages to be received,
means (53) for retrieving information from a third party from a database (DB) that is in a data transmission connection with the message centre, according to the criteria defined by subscriber B for information from a third party to be transmitted to him/her,
means (52) for transmitting a message and information from a third party in connection with the message to subscriber B on the basis of address data included in the message,
means (52) for charging a third party for at least part of the charge incurred by transmitting the message and/or at least a part of the price of the contents of the message transmitted.

22. A message centre (MC) as claimed in claim 21, characterized in that the message centre (MC) is a short message message centre in a mobile communication network.

23. A message centre (MC) as claimed in claim 21, characterized in that the message centre is a multimedia message centre in a mobile communication network.
